(19) United States
(12) Patent Application Publication
(10) Pub. No.: US 2022/0366428 A1
(43) Pub. Date: Nov. 17, 2022

(54) INFORMATION PROCESSING APPARATUS, INFORMATION PROCESSING METHOD, AND VEHICLE

(71) Applicant: TOYOTA JIDOSHA KABUSHIKI KAISHA, Toyota-shi (JP)

(72) Inventor: Satoru SAKUMA, Nagakute-shi (JP)

(21) Appl. No.: 17/742,565

(22) Filed: May 12, 2022

(30) Foreign Application Priority Data
May 17, 2021 (JP) 2021-083400

(51) Int. Cl. G06Q 30/00

(52) U.S. Cl. CPC G06Q 30/016

(57) ABSTRACT

An information processing apparatus includes a controller configured to perform: obtaining information relating to an operation to cancel a contract for a service provided in a vehicle; and, when obtaining the information relating to the operation to cancel the contract for the service, causing an information relating to a request when a second user, which differs from a first user to which the service is contracted, cancels the contract to be displayed on a display of the vehicle.

### CROSS REFERENCE TO THE RELATED APPLICATION

This application claims the benefit of Japanese Patent Application No. 2021-083400, filed on May 17, 2021, which is hereby incorporated by reference herein in its entirety.

### BACKGROUND

### Technical Field

The present disclosure relates to an information processing apparatus, an information processing method, and a vehicle.

### Description of the Related Art

Various services (telematics services) can be utilized using mobile communication. For example, it is known that: a driving related information related to driving of a driver is transmitted from an in-vehicle terminal to a server via a communication line; server determines the driving state of driver based on the driving related information; and the insurance company terminal calculates the automobile insurance premium based on the judgment result (for example, refer to Patent Document 1). When such a telematics service is contracted, the contracted information is stored in vehicle or server, so that the telematics service can be used without inputting information on the contract thereafter.

### PRIOR ART DOCUMENTS

### Patent Document

[Patent Document 1] JP-A-2002-149984

### SUMMARY

A primary user contracting for telematics services may sell a vehicle without canceling the telematics services. In order to cancel the service, for example, it is necessary to enter a password, etc., so it is difficult for a secondary user who does not know the password, etc. to cancel the contract. Therefore, the secondary user who purchased the used car may not be able to use the telematics services.

It is an object of this disclosure to facilitate the termination of a telematics service if the prior owner of a vehicle has contracted for that telematics service.

One aspect of the present disclosure is an information processing apparatus comprising a controller configured to perform: obtaining information relating to an operation to cancel a contract for a service provided in a vehicle; and, when obtaining information relating to the operation to cancel the contract for the service, causing an information relating to a request when a second user, which differs from the first user to which the service is contracted, cancels the contract to be displayed on a display of the vehicle.

One aspect of the present disclosure is an information processing method for causing a computer to perform: obtaining information relating to an operation to cancel a contract for a service provided in a vehicle; and, when obtaining information relating to the operation to cancel the contract for the service, causing an information relating to a request when a second user, which differs from the first user to which the service is contracted, cancels the contract to be displayed on a display of the vehicle.

One aspect of the present disclosure is a vehicle comprising a controller configured to perform: obtaining information relating to an operation to cancel a contract for a service provided in a vehicle; and, when obtaining information relating to the operation to cancel the contract for the service, causing an information relating to a request when a second user, which differs from the first user to which the service is contracted, cancels the contract to be displayed on a display of the vehicle.

Another embodiment of the present disclosure relates to a program for causing a computer to execute the above-described information processing method, or a storage medium in which the program is non-temporarily stored.

The disclosures may facilitate termination of a telematics service if the prior owner of a vehicle has subscribed to that service.

### BRIEF DESCRIPTION OF THE DRAWINGS

FIG. 1 is a diagram showing a schematic configuration of a system according to an embodiment.

FIG. 2 is a schematic diagram showing an exemplary configuration of each of a vehicle, user terminal, server, and supporting terminal constituting a system according to the embodiment.

FIG. 3 is a diagram illustrating a functional configuration of a server.

FIG. 4 is a diagram exemplifying a table structure of vehicle information stored in a vehicle information DB.

FIG. 5 is a diagram illustrating a functional configuration of a vehicle.

FIG. 6 is a diagram showing an exemplary connected menu displayed on a touch panel after a vehicle is started.

FIG. 7 is a diagram exemplifying a screen on which a service menu is displayed.

FIG. 8 is a diagram illustrating an example of an authentication screen for cancellation.

FIG. 9 is a diagram illustrating a screen for canceling a service.

FIG. 10 is a diagram when a touch button for the secondary user to request cancellation is displayed on the cancellation authenticating screen.

FIG. 11 is a diagram showing an example of a screen displayed after tapping the touch button described as “request cancellation” in FIG. 10.

FIG. 12 is a sequence diagram showing the entire process of a system.

FIG. 13 is a flowchart of the process by which a server provides telematics services to a user.

FIG. 14 is a flow chart of the process in a vehicle.

### DESCRIPTION OF THE EMBODIMENTS

One aspect of the present disclosure is an information processing apparatus comprising a controller configured to perform: obtaining information relating to an operation to cancel a contract for a service provided in a vehicle; and, when obtaining information relating to the operation to cancel the contract for the service, causing an information relating to a request when a second user, which differs from the first user to which the service is contracted, cancels the contract to be displayed on a display of the vehicle.

The service is, for example, a telematics service. Examples of the services include those for displaying weather forecasts, news, or traffic congestion information on a display in the vehicle, those for remotely controlling a device provided in the vehicle by using a terminal of a user, and those for transmitting position information of the vehicle to a user terminal. Contracts are required to use some or all of the services. The contract for the services is, for example, a contract in which a user can use contents by paying a monthly usage fee. This contract may be made by a user or by a vehicle distributor. The contract may also be, for example, with an enterprise providing the service.

The first user is, for example, a user who was the previous owner of the vehicle and contracted for the services. The first user has contracted for the service prior to selling vehicle, and has sold the vehicle without canceling the contract for the service. For example, a password, PIN, or user account is set when the service is contracted. Here, in order to improve the convenience of the user, once a password or the like is entered, the service may be available without entering the password or the like thereafter. Alternatively, input of the password or the like may be requested each time the service is used. However, to confirm that the request to cancel the service is a request from a legitimate user, the user is required to enter the password, etc.

For example, the second user is the user who bought the vehicle that the primary user was servicing. Since the second user does not know the password corresponding to the service, it is difficult for the second user to terminate the contract. It can also be problematic for the second user to cancel the contract that the first user has signed.

Therefore, the controller first acquires information on the operation to cancel the contract of the services provided in the vehicle. The information for this operation is the information in which it can be determined that the first user or the second user wishes to cancel the contract. For example, the information for an action includes the information that is printed when the user taps the touch button that is displayed for cancelling the contract.

Next, when the controller obtains the information relating to the operation to cancel the contract for the service, the controller causes the information relating to a request when a second user, which differs from the first user to which the service is contracted, cancels the contract to be displayed on a display of the vehicle. “A request when a second user cancels the contract” is, for example, the request made to a person who can terminate the contract on behalf of the first user, a terminal, or a server. The second user can cancel the contract of the services by requesting cancellation of the contract. Therefore, the second user can cancel the service contract without knowing the password, etc. In addition, since the request destination for cancellation of the contract is displayed on the display, the second user can immediately request cancellation of the contract without checking the request destination by itself. In this manner, cancellation of the contract can be promoted.

Hereinafter, embodiments of the present disclosure will be described based on the drawings. The configuration of the following embodiments is illustrative, and the present disclosure is not limited to the configuration of the embodiments. The following embodiments can be combined.

### First Embodiment

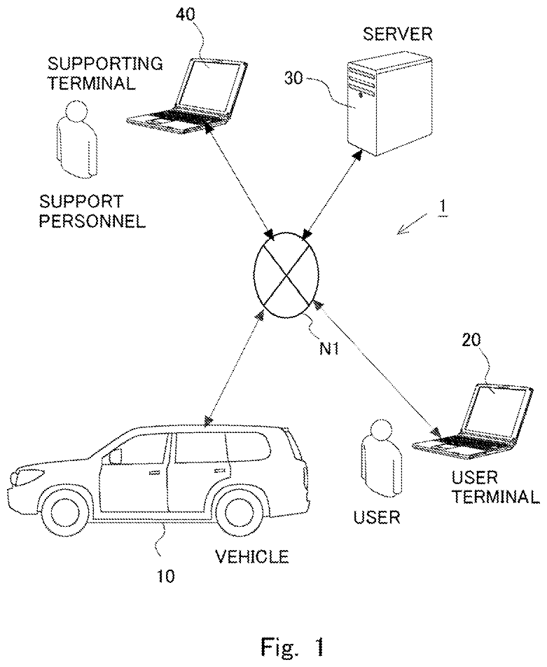

FIG. 1 is a diagram showing a schematic configuration of a system 1 according to the present embodiment. The system 1 is a system for causing a vehicle 10, which has contracted a telematics service (hereinafter, simply referred to as a service) in a user terminal 20 when purchasing the vehicle 10, to display an information relating to cancellation of the contract on a display provided in the vehicle 10. When subscribing to the services, an information relating to the user and an information relating to the vehicle 10 are linked and stored in the vehicle 10 or a server 30.

If the first owner (primary user) of the vehicle 10 sells the vehicle 10 without canceling the services, an information at which the primary user signed up remains in the vehicle 10 or the server 30. In this situation, even if a user (secondary user) who subsequently purchases the vehicle 10 attempts to sign up for the service, it may not be possible to sign up due to the primary user's uncancelled service. In this case, the secondary user may not be able to use the service. Also, for example, if the primary user has subscribed to a service that notifies the user terminal 20 of a position information of the vehicle 10, the position information of the secondary user may be known to the primary user.

On the other hand, in the present embodiment, the information relating to the request to cancel the contract of the services is displayed on the display of the vehicle 10 itself. The display shows, for example, a contact for the secondary user who wishes to cancel the contract from the primary user to request the cancellation of the contract. The contact may be, for example, a support center telephone number, fax number, email address, or a Uniform Resource Locator. The secondary user then requests the support center to terminate the primary user contract. At the support center, an employee (hereinafter also referred to as a support personnel) operates a supporting terminal 40 to cancel the contract of the primary user. It is also possible to request the server 30 to terminate the contract from the support center. Alternatively, URLs for requesting the server 30 to cancel the contract may be displayed on the display of the vehicle 10 as the information relating to the request. The secondary user may then request the server 30 to terminate the contract by accessing the URL from the vehicle 10 or the user terminal 20 and entering a predetermined value. As a further alternative, a touch button for requesting cancellation of the contract may be displayed on the display of the vehicle 10 as the information relating to the request to cancel the contract of the services. By tapping this touch button, the information may be sent to the server 30, for example, to request the termination of the contract.

In the embodiment of FIG. 1, the system 1 includes the vehicle 10, the user terminal 20, the server 30, and the supporting terminal 40. The user terminal 20 is a terminal used by an owner of the vehicle 10 or an employee of the dealer. For example, the user may request the dealer to contract or cancel the service. The vehicle 10 is a vehicle owned by the user. A previous owner of the vehicle 10 has contracted the service in the vehicle 10. The supporting terminal 40 is a terminal used by support personnel.

The vehicle 10, the user terminal 20, the server 30, and the supporting terminal 40 are interconnected by a network N1. Note that the network N1 is, for example, a worldwide public communication network such as the Internet. A WAN (Wide Area Network) or other communication network may be employed. The network N1 may include a telephone communication network, such as a cellular telephone, or a wireless communication network, such as Wi-Fi.

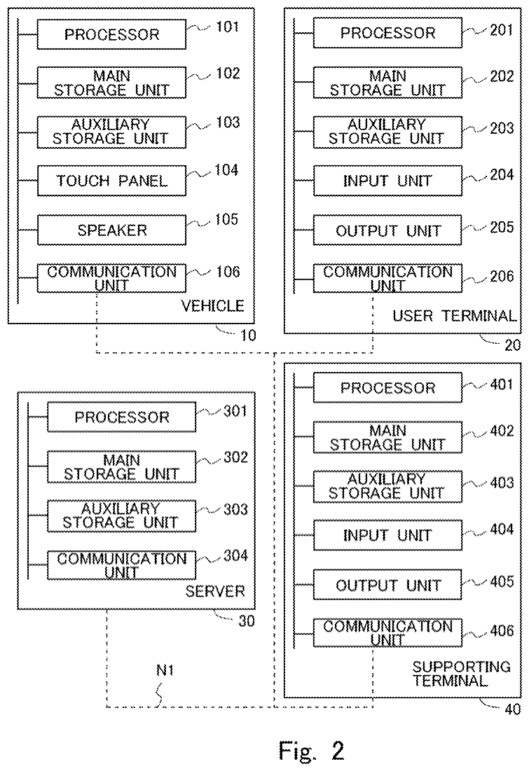

A hardware configuration of the vehicle 10, the user terminal 20, the server 30, and the supporting terminal 40 will be described with reference to FIG. 2. FIG. 2 is a block diagram schematically showing an exemplary configuration of each of the vehicle 10, the user terminal 20, the server 30, and the supporting terminal 40 constituting the system 1 according to the present embodiment.

The server 30 has a computer configuration. The server 30 provides services to the user riding on the vehicle 10. The server 30 includes a processor 301, a main storage unit 302, an auxiliary storage unit 303, and a communication unit 304. These are interconnected by a bus.

The processor 301 is a CPU (Central Processing Unit), DSP (Digital Signal Processor), or the like. The processor 301 controls the server 30 to perform various information processing operations. The main storage unit 302 is RAM (Random Access Memory), ROM (Read Only Memory) or the like. The auxiliary storage unit 303 may be an EPROM (Erasable Programmable ROM), a hard disk drive (HDD, Hard Disk Drive), a removable medium, or the like. The auxiliary storage unit 303 stores an operating system (Operating System: OS), various programs, various tables, and the like. Processor 301 loads and runs the program stored in auxiliary storage unit 303 into main storage unit 302 workspace. Then, each component or the like is controlled through the execution of the program. This allows the server 30 to perform functions that meet a given objective. The main storage unit 302 and the auxiliary storage unit 303 are computer readable recording media. Note that the server 30 may be a single computer, or may be a combination of a plurality of computers. The information stored in the auxiliary storage unit 303 may be stored in the main storage unit 302. The information stored in the main storage unit 302 may be stored in the auxiliary storage unit 303.

The communication unit 304 communicates with the vehicle 10, the user terminal 20, and the supporting terminal 40 via the network N1. The communication unit 304 may be, for example, a LAN (Local Area Network) interface board or a wireless communication circuitry for a wireless communication. The LAN interface boards and the wireless communication circuits are connected to the network N1.

Next, the user terminal 20 will be described. The user terminal 20 is, for example, a small computer such as a smart phone, a mobile phone, a tablet terminal, a personal information terminal, a wearable computer (smart watch, etc.), or a personal computer (PC). The user terminal 20 includes a processor 201, a main storage unit 202, an auxiliary storage unit 203, an input unit 204, an output unit 205, and a communication unit 206. These are interconnected by a bus. The processor 201, the main storage unit 202, the auxiliary storage unit 203, and the communication unit 206 are the same as the processor 301, the main storage unit 302, the auxiliary storage unit 303, and the communication unit 304 described above, and therefore descriptions thereof are omitted.

The input unit 204 is a device for accepting input operations performed by the user, and is, for example, a touch panel, a mouse, a keyboard, or a microphone. The output unit 205 is a device of presenting the information to the user, for example, LCD (Liquid Crystal Display), EL (Electroluminescence) panels, a speaker, a lamp, and the like. The input unit 204 and the output unit 205 may be configured as a single touch panel display.

Next, the vehicle 10 will be described. The vehicle 10 has a processor 101, a main storage unit 102, an auxiliary storage unit 103, a touch panel 104, a speaker 105, and a communication unit 106. These are interconnected by a bus. The processor 101, the main storage unit 102, the auxiliary storage unit 103, and the communication unit 106 are the same as the processor 201, the main storage unit 202, the auxiliary storage unit 203, and the communication unit 206 described above, and therefore descriptions thereof are omitted. The processor 101 of the vehicle 10 or the processor 301 of the server 30 is an example of a controller. The main storage unit 102 or the auxiliary storage unit 103 of the vehicle 10 or the main storage unit 302 or the auxiliary storage unit 303 of the server 30 is an example of a storage.

The touch panel 104 is a device for accepting input operations performed by the user, and also a device for presenting information to the user. The touch panel 104 includes a display (e.g., an LCD (Liquid Crystal Display) or an EL (Electroluminescence) panel, etc.). The speaker 105 is a device that plays sound into the car.

Next, the supporting terminal 40 will be described. The supporting terminal 40 is, for example, a small computer such as a smart phone, a mobile phone, a tablet terminal, a personal information terminal, a wearable computer (smart watch, etc.), or a personal computer (PC). The supporting terminal 40 includes a processor 401, a main storage unit 402, an auxiliary storage unit 403, an input unit 404, an output unit 405, and a communication unit 406. These are interconnected by a bus. Since these are similar to the processor 201, the main storage unit 202, the auxiliary storage unit 203, the input unit 204, the output unit 205, and the communication unit 206 of the user terminal 20, the description thereof will be omitted.

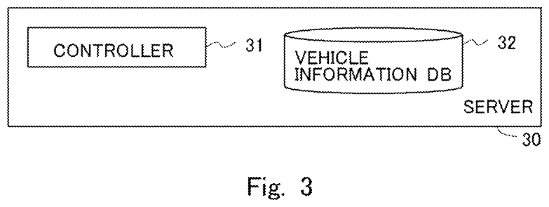

Next, the functions of the server 30 will be described. FIG. 3 is a diagram illustrating a functional configuration of the server 30. The server 30 includes a controller 31 and a vehicle information DB 32 as functional components. The processor 301 of the server 30 performs the process of the controller 31 by a computer program on the main storage unit 302. A part of the process of the controller 31 may be executed by another computer connected to the network N1.

The vehicle information DB 32 is built by a program of a database management system (DBMS) that is executed by the processor 301 to manage data stored in the auxiliary storage unit 303. The vehicle information DB 32 is, for example, a relational database.

Controller 31 receives a use start request from the user terminal 20. The use start request is a request to conclude a service contract. The use start request includes an information related to the vehicle 10 and an information related to the user. Upon receiving the use start request, the controller 31 executes a use start process. In the use start process, an information related to the user is stored in the vehicle information DB 32 in association with an information related to the vehicle 10. The vehicle information table includes fields of vehicle ID, user account, password, name, address, telephone number, and contract content.

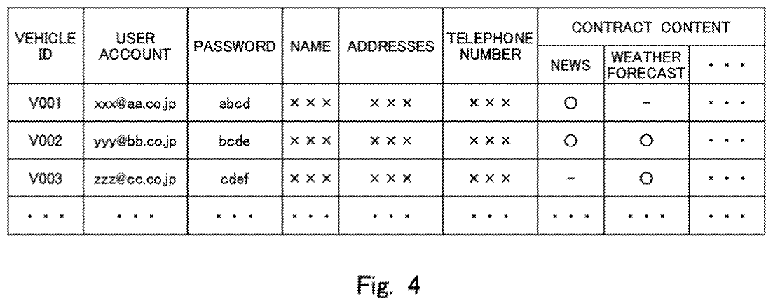

FIG. 4 is a diagram exemplifying a table structure of vehicle information stored in the vehicle information DB 32. The vehicle information table includes fields of vehicle ID, user accounts, passwords, names, addresses, telephone numbers, and contract contents. The vehicle ID, which is an information for specifying the vehicle 10, is entered in the vehicle ID field. The user account field is populated with the user account, which is an information used to identify the user. For example, user's e-mail address is used for the user account. The password field is populated with the password set by the user or the controller 31. This password is required when the user uses the service or cancels the service contract. In the name field, the name of the user is entered. The address field is populated with the address of the user. The telephone number field is populated with the telephone number of the user. The contract content field is populated with an information that identifies the content that the user is subscribing to. The content includes, for example, a voice message of a weather forecast, a voice message of news, a display of an Internet browser on the touch panel 104, or a call with an operator. The contents can be contracted at the retailer when the vehicle 10 is purchased, or the user can be added from a menu screen displayed on the touch panel 104.

Based on the contract content stored in the vehicle information DB 32, the controller 31 transmits an information, for displaying images corresponding to the contract content on the touch panel 104 of the vehicle 10, to the vehicle 10.

In addition, the controller 31 transmits the information relating to user accounts to the vehicle 10 as an information to be displayed on the menus of the services. In the present embodiment, the user account (i.e., e-mail address) is displayed on the menu screen of the services, but the name, nickname, telephone number, and the like of the user may alternatively be displayed on the menu screen of the services. In the present embodiment, the information on the user account may be transmitted to the vehicle 10 so that a part of the user account is replaced with a symbol or the like and displayed on the menus.

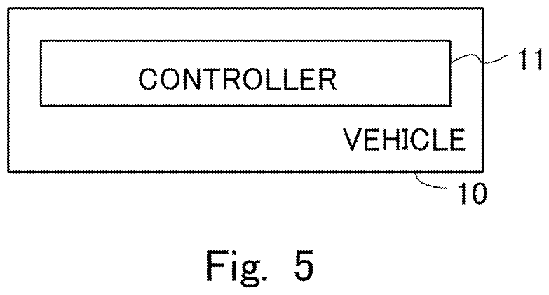

Next, the function of the vehicle 10 will be described. FIG. 5 is a diagram illustrating a functional configuration of the vehicle 10. The vehicle 10 includes a controller 11 as a functional component. The processor 101 of the vehicle executes the processes of the controller 11 by the computer programs on the main storage unit 102.

The controller 11 communicates with the server 30 each time the vehicle 10 is activated. The activation of the vehicle 10 includes at least the fact that the contents are available. The activation of the vehicle 10 also includes a so-called accessory mode (a mode in which the vehicle 10 cannot be driven but power is supplied to various devices). Alternatively, activation of the vehicle 10 may include turning on a so-called ignition switch. As a further alternative, vehicle 10 may be considered to have been activated when the user presses the start switch of the vehicle 10.

After activation of the vehicle 10, the controller 11 receives the information about the available content, which may be contract content, from the server 30. Based on this information, the controller 11 causes the touch panel 104 to display a screen (hereinafter also referred to as a connected menu) on which the available contents can be selected. On this connected menu screen, touch buttons corresponding to available contents are displayed. When the user taps a touch button, the controller 11 transmits a request to the server 30 to use the content. The controller 11 provides the user with information sent from the server 30 on demand. For example, if the user taps the weather forecast touch button on the connected menu screen, the server 30 transmits weather forecast information to the vehicle 10. In the vehicle 10, for example, the controller 11 will cause a weather forecast to be output from the speaker 105 or cause the touch panel 104 to show the weather forecast.

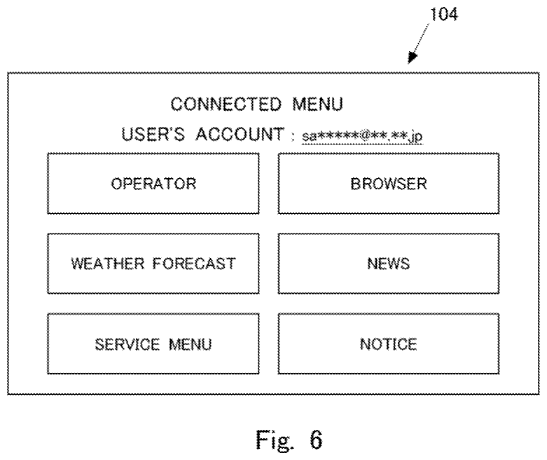

FIG. 6 is a diagram showing an exemplary connected menu displayed on the touch panel 104 after the vehicle 10 is activated. The connected menu displays a touch button on which the available contract content can be selected. In this case, the user account is displayed on the screen. In the embodiment shown in FIG. 6, the user e-mail address is used as the user account, and a part of the e-mail address is displayed on the touch panel 104 by replacing the e-mail address with a symbol. Even if a part of the email address is replaced by a symbol, it is recognizable to the user if it is the user's own email address. On the other hand, if an email address is displayed that differs from the user's own email address, the user can recognize that it is another person's account. In this embodiment, the user account is sent from the server 30, but may alternatively be stored in the auxiliary storage unit 103 of the vehicle 10.

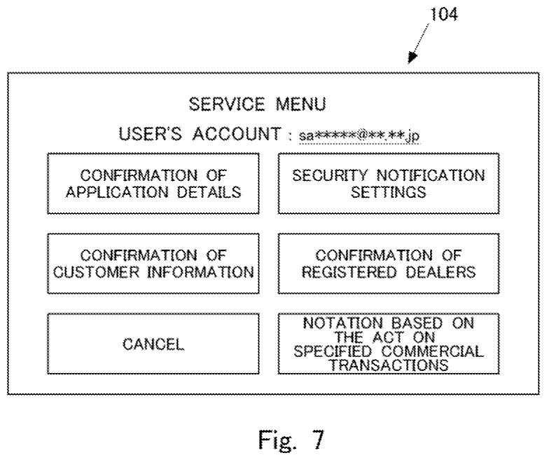

The connected menu also displays a touch button (a touch button indicated by “service menu” in FIG. 6) for the user to move to the screen of the service menu that allows the user to confirm the content of the contract and cancel the contract. When the user opens the service menu by tapping the “service menu” touch button, the user account is also displayed on the screen. FIG. 7 is a diagram exemplifying a screen on which the service menu is displayed. Also, in the embodiment shown in FIG. 7, the user e-mail address is used as the user account, and a part of the e-mail address is replaced with a symbol and displayed on touch panel 104. The user accounts may be displayed on only one of the connected menu shown in FIG. 6 and the services menu shown in FIG. 7.

By displaying the user accounts on the touch panel 104 as shown in FIGS. 6 and 7, the secondary user can be made aware that the primary user contract has not been released or cancelled. As a result, the cancellation of the contract can be promoted to the secondary user.

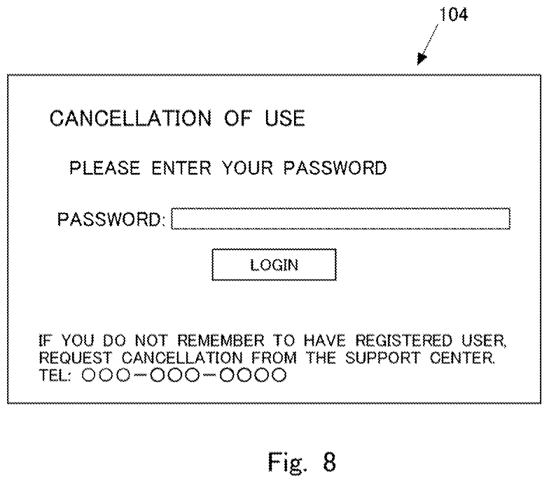

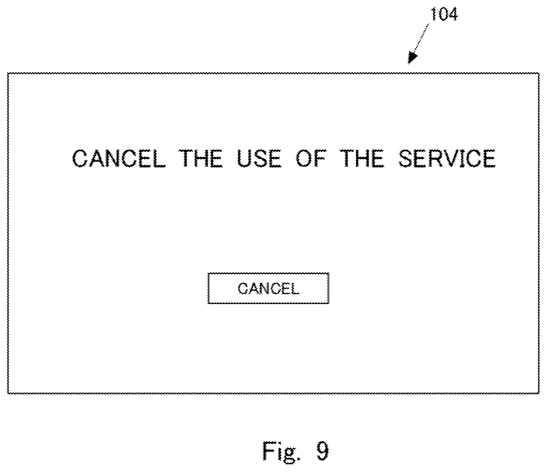

When the user taps the “CANCEL” button in the service menu, the controller 11 causes the touch panel 104 to display an authentication screen for canceling the service shown in FIG. 8. FIG. 8 is a diagram illustrating an example of an authentication screen for cancellation. In the embodiment shown in FIG. 8, the controller 11 displays a window for inputting a password. When the user taps the “LOGIN” touch button after entering the password, the controller 11 transmits to the server 30 the vehicle ID, the user account, and the entered password. The server 30 authenticates the user and an information is sent from the server 30 to show the screen shown in FIG. 9 when the authorization is successful. Based on this information, the controller 11 displays the window shown in FIG. 9. FIG. 9 is a diagram illustrating a screen for canceling the service. When the user taps the “CANCEL” touch button, the controller 11 transmits an information to the server 30 for each of the vehicle ID, the user accounts, and the request for cancellation. Upon receiving this information, the server 30 terminates the service by deleting the record corresponding to the vehicle ID, for example.

On the other hand, if the user is the secondary user and the primary user contract has not been cancelled, the password cannot be entered on the screen shown in FIG. 8. However, the screen shown in FIG. 8 displays a message prompting the support center to contact and a telephone number. In other words, information relating to the request when the secondary user cancels the contract is shown. The user can call this number to ask the support center to terminate the primary user contract.

In the present embodiment, the user requests the support center to cancel the contract by telephone, but alternatively, the user may request the support center to cancel the contract by e-mail. In this case, the screen shown in FIG. 8 displays the e-mail address of the support center instead of the telephone number. Instead of canceling the contract immediately, the support center that has received the request for cancellation may send the request for cancellation by mail to the user, and user may return the request to the support center after completing the specified items in the request. Then, the request form returned at the support center may be checked, and if there is no problem, the contract may be canceled. At this time, copies of documents (e.g., vehicle validation and driver's license) that can prove that the user is the legitimate owner of the vehicle 10 may be sent to the support center.

Alternatively, the URL that can request the supporting terminal 40 or the support server 30 to cancel the contract may be displayed on the screen shown in FIG. 8. For example, the cancellation of the contract may be requested by connecting to a predetermined URL from the vehicle 10 or the user terminal 20 and inputting a predetermined information.

In this way, the user can easily request the cancellation of the contract because the contact information for requesting the cancellation of the contract is displayed on the screen without inputting the passwords.

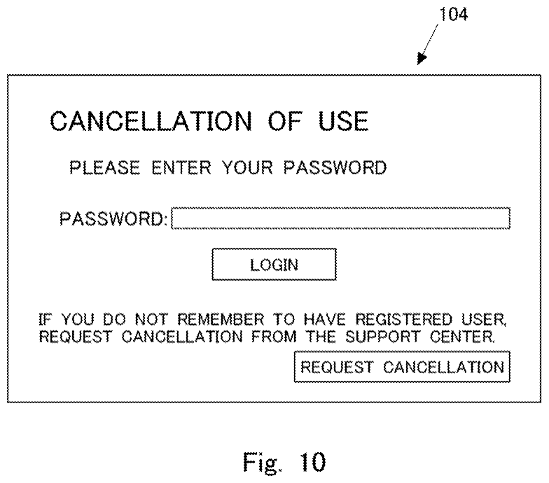

Although FIG. 8 shows an example in which the contact address of the support center is displayed, alternatively, as shown in FIG. 10, a touch button for requesting cancellation may be displayed. Here, FIG. 10 is a diagram when a touch button for the secondary user to request cancellation is displayed on the cancellation authenticating screen. FIG. 10 can also be referred to as a screen displayed on the touch panel 104 when confirming whether the operation to cancel the contract of services is performed from a legitimate user (contracted user). As shown in FIG. 10, for example, a touch button describing “REQUEST CANCELLATION” is displayed together with the phrase “If you do not remember to have registered user, request cancellation from the support center.”. These are information relating to the request when the user cancels the contract. The user can request the server 30 or the supporting terminal 40 to cancel the contract without knowing the password by tapping the touch button labeled “REQUEST CANCELLATION”. At this time, the user requesting termination may be prompted for an information relating to the user.

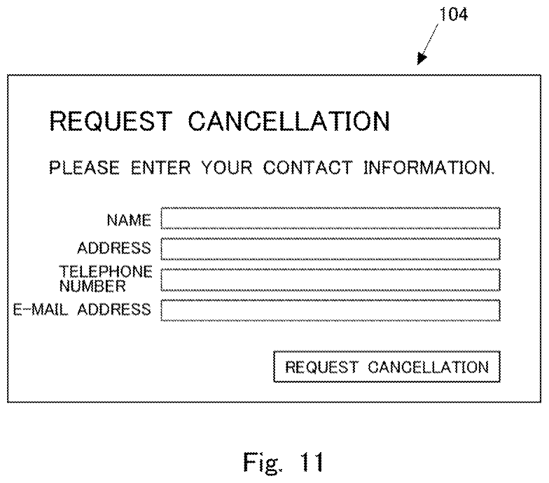

Here, FIG. 11 is a diagram showing an example of a screen displayed after tapping the touch button described as “REQUEST CANCELLATION” in FIG. 10. Here, the user is prompted for an information to identify the user. In FIG. 11, the information entered by user is sent to the server 30 or the supporting terminal 40 by entering the user's name, address, telephone number, and e-mail address and then tapping the touch button labeled “Request cancellation”.

The server 30 or the supporting terminal 40, for example, mails the application form to the address entered by the user and asks the user to complete the application form and return it. At this time, for example, a copy of the vehicle verification may be requested to be attached. By confirming the address and the vehicle verification in this manner, for example, when a legitimate user (a user having a contract) lends the vehicle 10 to an acquaintance, the acquaintance can be prevented from canceling the service by itself. Similarly, the image data of the vehicle verification may be sent by e-mail, or the image data of the vehicle verification may be uploaded by accessing a predetermined URL. These data may be confirmed by the support personnel via the output unit 405 of the supporting terminal 40, or may be confirmed by the controller 31 of the server 30 performing an image process.

Further, by pressing the button “REQUEST CANCELLATION” shown in FIG. 11, not only the existing contract is cancelled, but also the user requesting cancellation of the contract may be registered as a new user. In this instance, the controller 11 of the vehicle 10 transmits information of each of the vehicle ID, name, address, telephone number, and e-mail address to the server 30, and the controller 31 of the server 30 stores this information in the vehicle information DB 32.

In addition, the sending of copies of the vehicle verification or the transmitting of the image data is not indispensable, and for example, by pressing a touch button described as “REQUEST CANCELLATION” shown in FIG. 11, an information for requesting cancellation is sent to the server 30 or the supporting terminal 40, and the server 30 or the supporting terminal 40 may cancel the service based on this information. Also, by pressing the touch button labeled “REQUEST CANCELLATION” shown in FIG. 10, the information for requesting cancellation is transmitted to the server 30 or the support terminal 40, and the server 30 or supporting terminal 40 may cancel the service based on this information.

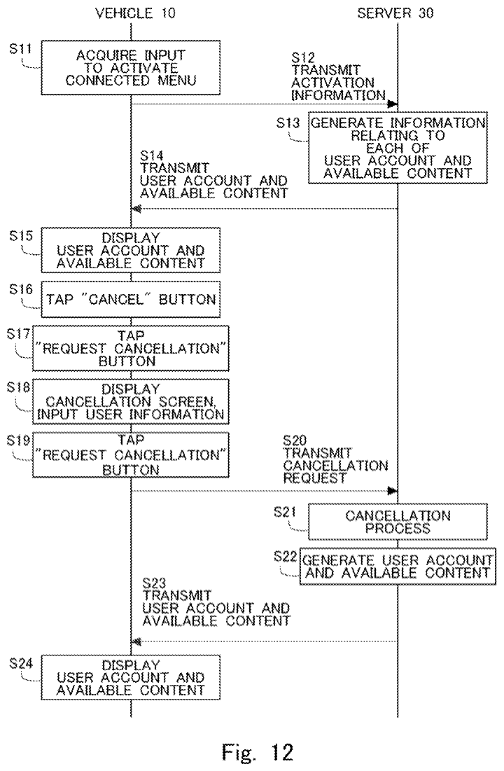

Next, the entire process of the system 1 will be described. FIG. 12 is a sequence diagram showing the entire process of the system 1. In FIG. 12, it is assumed that the secondary user requests cancellation of the service while the service contract by the primary user is still in effect. In other words, the vehicle information DB 32 stores an information in which the primary user is linked to the vehicle 10. FIG. 12 also assumes that the user directly requests the server 30 to cancel the service.

For example, when the user makes a predetermined input to the touch panel 104 in an attempt to activate the connected menu after the vehicle 10 is activated, the vehicle 10 acquires the input (S11) and transmits it to the server as an activation information (S12). The activation information contains the vehicle ID. The server 30, which has acquired the activation information, accesses the vehicle information DB 32 to extract a record corresponding to the vehicle ID. Then, an information relating to each of the user accounts and the available contents included in the record is generated (S13) and transmitted to the vehicle 10 (S14).

In the vehicle 10, the information relating to the user account and the available contents are stored in the auxiliary storage unit 103, and the user account and the available content are displayed in the connected menu displayed on the touch panel 104 (S15). When the user taps the “SERVICE MENU” touch button shown in FIG. 6 and further taps the “CANCEL” touch button of the service menu shown in FIG. 7 (S16), a screen for canceling the use shown in FIG. 10 is displayed on the touch panel 104 of the vehicle 10. Further, when user taps the touch button “REQUEST CANCELLATION” shown in FIG. 10 (S17), a screen for inputting information of the user requesting cancellation shown in FIG. 11 is displayed on the touch panel 104 of the vehicle (S18). The user enters information in the items shown in FIG. 11, and then taps the touch button of “REQUEST CANCELLATION” (S19). Then, the vehicle ID, the cancellation request, and the information entered by the user are sent to the server 30 as a cancellation request (S20).

In the server 30, upon receiving the cancellation request, the cancellation process is executed (S21). In this cancellation process, the record of the corresponding vehicle ID of the vehicle information DB 32 is updated with an information entered by user. When the updating of the vehicle information DB 32 is completed, the vehicle information DB 32 is accessed to extract a record corresponding to the vehicle ID. Then, an information relating to each of the user accounts and the available contents included in the record is generated (S22) and transmitted to the vehicle 10 (S23). In step S24, the vehicle 10 stores the information on each of the user account and the available content in the auxiliary storage unit 103 and causes the user account and the available content to be displayed on the connected menu displayed on the touch panel 104. At this time, the user account displayed on the touch panel 104 is e-mail addresses entered on the screen shown in FIG. 11.

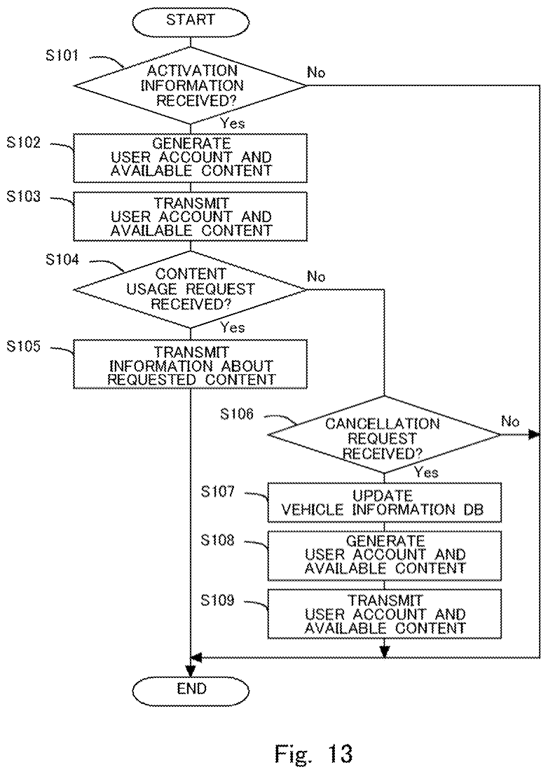

FIG. 13 is a flowchart illustrating a process in which the server 30 provides telematics services to the user. The process shown in FIG. 13 is repeatedly executed at predetermined intervals in the server 30.

In step S101, the controller 31 determines whether or not the activation information has been received from the vehicle 10. If an affirmative determination is made in step S101, the routine proceeds to step S102, and if a negative determination is made, the routine is terminated. In step S102, the controller 31 generates available contents and the user account. The available contents are the contents available to the user and are contracted to by the user. Since the available contents are stored in the vehicle information DB 32, the controller 31 extracts a record of the vehicle information DB 32 corresponding to the vehicle ID. The controller 31 reads user accounts stored in the same record of the vehicle information DB 32. Then, the controller 31 generates an information for transmitting to the vehicle 10. This information contains the information about the available contents and the information about the user account. In step S103, the controller 31 transmits the information about the available contents and the information about the user account to the vehicle 10.

In step S104, the controller 31 determines whether or not a content usage request has been received from the vehicle 10. The content usage request is a request that a user utilizes the content tapped on the connected menu of FIG. 6. If an affirmative determination is made in step S104, the process proceeds to step S105, and if a negative determination is made, the process proceeds to step S106. In step S105, the controller 31 transmits information about the requested content to the vehicle 10. For example, when a weather forecast is requested, audio data or image data relating to the weather is transmitted to the vehicle 10.

On the other hand, in step S106, the controller 31 determines whether or not a cancellation request has been received from the vehicle 10. The cancellation request is transmitted from the vehicle 10 to the server 30, for example, when the user taps the touch button “REQUEST CANCELLATION” shown in FIG. 11. The cancellation request includes, for example, the vehicle ID, an information to request cancellation, and an information (e.g., name, address, telephone number, and e-mail address) about the user that requested the cancellation. It should be noted that the information related to a user requesting cancellation need not necessarily be included. If an affirmative determination is made in step S106, the routine proceeds to step S107, and if a negative determination is made, the routine is terminated.

In step S107, the controller 31 updates the vehicle information DB 32. The controller 31 updates the record of the vehicle information DB 32 corresponding to the vehicle ID. At this time, for example, a new user may be registered in the vehicle information DB 32 on the basis of the information relating to a user requesting the cancellation. In this instance, the user requesting cancellation is registered as the user that subscribed to the services. At this time, the information for the contract contents stored in the contract contents field of the vehicle information DB 32 is deleted, so that a new user will not be able to use the contents that need to be subscribed. Alternatively, the user account corresponding to the vehicle 10 may be deleted by deleting the record corresponding to the vehicle ID from the vehicle information DB 32. This cancels the contract, so that when a new user uses the services, a new contract needs to be made.

In step S108, the controller 31 generates the available contents and the user account. The available content is the content available to the user and is contracted to by the user. Since the available contents are stored in the vehicle information DB 32, the controller 31 reads the information of the vehicle information DB 32. However, since the information for the available content has been deleted in the step S107 above, an information will be loaded to indicate that there is no available content. The controller 31 reads the user accounts corresponding to the vehicle ID of the vehicle information DB 32. Then, the controller 31 generates the information for transmitting to the vehicle 10. This information contains the information about available contents and the information about the user accounts. In step S109, the controller 31 transmits the information about available contents and the information about the user accounts to the vehicle 10.

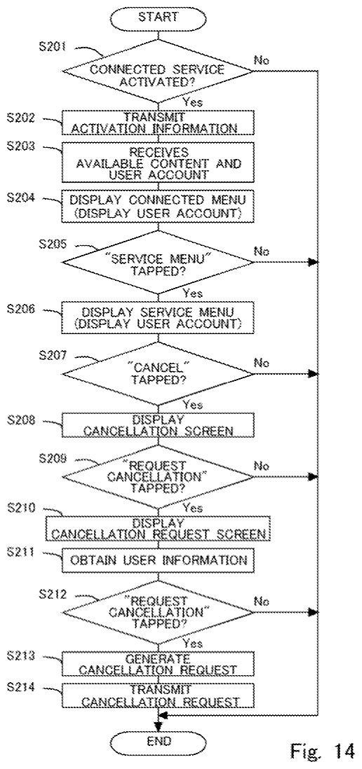

Next, FIG. 14 is a flow chart of the process in the vehicle 10. The process shown in FIG. 14 is repeatedly executed at predetermined intervals in the vehicle 10.

In step S201, the controller 11 determines whether or not the connected service has been activated. For example, the user may activate the connected service by tapping a predetermined location on the touch panel 104. Thus, the controller 11 may determine whether a predetermined location of the touch panel 104 has been tapped. If an affirmative determination is made in step S201, the routine proceeds to step S202, and if a negative determination is made, the routine is terminated.

In step S202, the controller 11 transmits an activation information to the server 30. The activation information is an information containing the vehicle ID and an information indicating that connected services have been started. In step S203, the controller 11 receives the information about the available content and the information about the user account from the server 30. In step S204, controller 11 displays a connected menu for using the connected service on the touch panel 104. At this time, all or part of the user accounts are also displayed. This connected menu corresponds to the screen shown in FIG. 6.

In step S205, the controller 11 determines whether or not the user tapped the touch button of the “SERVICE MENU”. If an affirmative determination is made in step S205, the routine proceeds to step S206, and if a negative determination is made, the routine is terminated. If a negative determination is made at step S205, the process corresponding to the touch button tapped by the user is executed after the end of this routine.

In step S206, the controller 11 displays the service menu for using the service on the touch panel 104. At this time, all or part of the user accounts are also displayed. The service menu corresponds to the screen shown in FIG. 7. In step S207, the controller 11 determines whether or not the user tapped the “CANCEL” touch button. If an affirmative determination is made in step S207, the routine proceeds to step S208, and if a negative determination is made, the routine is terminated. If a negative determination is made at step S207, the process corresponding to the touch button tapped by the user is executed after the end of this routine.

In step S208, the controller 11 displays the cancellation screen on the touch panel 104. This cancellation screen corresponds to the screen shown in FIG. 10. Alternatively, the screen shown in FIG. 8 may be displayed. In this event, the user will contact the support center and apply for cancellation of the support center on its own. In step S209, the controller 11 determines whether or not the user tapped the “REQUEST CANCELLATION” touch button. If an affirmative determination is made in step S209, the routine proceeds to step S210, and if a negative determination is made, the routine is terminated. When the user enters the password and taps the “LOGIN” touch button, the controller 11 displays the screen shown in FIG. 9. Then, when the user taps the “CANCEL” touch button, the controller 11 generates the cancel request and transmits it to the server 30.

In step S210, the controller 11 displays the cancellation request screen on the touch panel 104. The cancellation request screen corresponds to the screen shown in FIG. 11. In addition, in step S211, the controller 11 obtains the user information which is the information entered by the user. As shown in FIG. 11, the user is prompted for, for example, name, address, telephone number, and e-mail address. In step S212, the controller 11 determines whether or not the user tapped the “REQUEST CANCELLATION” touch button. If an affirmative determination is made in step S212, the routine proceeds to step S213, and if a negative determination is made, the routine is terminated.

In step S213, the controller 11 generates the cancellation request. The cancellation request here is an information for requesting the server 30 to cancel the service, and includes the vehicle ID, the information indicating that the user wishes to cancel, and the information entered by the user. Then, in step S214, the controller 11 transmits the cancellation request to the server 30. This cancellation request can be received and processed by the server 30 to cancel the contract made by the primary user.

As described above, according to the present embodiment, the user who has purchased vehicle 10 for which a contract for services has been made can know the contact address for canceling the contract. The user may also request cancellation of services. Thus, cancellation of the service can be promoted. In addition, the secondary user will feel uncomfortable because the primary user's user account will appear on the menu-screen. This triggers the secondary user to request the termination of the service.

### OTHER EMBODIMENTS

The embodiments described above are merely examples, and the present disclosure may be embodied while being changed as appropriate within the scope of the present invention.

The processes and means described in the present disclosure may be freely combined and embodied to the extent that no technical conflicts exist.

Furthermore, a process that is described to be performed by one apparatus may be shared and performed by a plurality of apparatuses. Processes described to be performed by different apparatuses may be performed by one apparatus. Which function is to be implemented by which hardware configuration (server configuration) in a computer system may be flexibly changed. For example, the vehicle 10 may have some or all of the functions of the user terminal 20. In addition, some or all of the functions of the supporting terminal 40 may be provided by the server 30.

The present disclosure can also be implemented by supplying a computer program that implements the functions described in the above-described embodiments to a computer, and reading and executing the program by one or more processors of the computer. Such computer programs may be provided to the computer by a non-transitory computer-readable storage medium that can be connected to a system bus of the computer, or may be provided to the computer through a network. The non-transitory computer-readable storage medium may be any type of disk including magnetic disks (floppy (registered trademark) disks, hard disk drives (HDDs), etc.) and optical disks (CD-ROMs, DVD discs, Blu-ray discs, etc.), read-only memories (ROMs), random access memories (RAMs), EPROMs, EEPROMs, magnetic cards, flash memories, optical cards, and any type of medium suitable for storing electronic instructions.

What is claimed is:

1. An information processing apparatus comprising a controller configured to perform:
obtaining an information relating to an operation to cancel a contract for a service provided in a vehicle; and,
when obtaining the information relating to the operation to cancel the contract for the service, causing information relating to a request when a second user, which differs from a first user to which the service is contracted, cancels the contract, to be displayed on a display of the vehicle.

2. The information processing apparatus according to claim 1, wherein
the controller displays the information relating to the request when confirming whether or not the operation to cancel the contract of the services has been performed from the first user.

3. The information processing apparatus according to claim 1, wherein
the controller displays information relating to the request when the first user inputs an account or a password to cancel the contract.

4. The information processing apparatus according to claim 1, wherein
the controller displays a telephone number in the information relating to the request.

5. The information processing apparatus according to claim 1, wherein
the controller displays, in the information relating to the request, information relating to URLs capable of requesting cancellation of the contract.

6. The information processing apparatus according to claim 1, wherein
the controller causes the display to display information relating to the first user.

7. The information processing apparatus according to claim 6, wherein
the controller causes information regarding the first user to be displayed on menus of the services.

8. The information processing apparatus according to claim 6, wherein
the controller displays information relating to the first user e-mail address on the display as the information relating to the first user.

9. The information processing apparatus according to claim 6, wherein
the controller displays the first user name or nickname on the display as the information relating to the first user.

10. The information processing apparatus according to claim 1, further comprising a storage that stores information about the contract associated with the vehicle and the first user.

11. An information processing method for causing a computer to perform:
obtaining information relating to an operation to cancel a contract for a service provided in a vehicle; and,
when obtaining information relating to the operation to cancel the contract for the service, causing an information relating to a request when a second user, which differs from a first user to which the service is contracted, cancels the contract, to be displayed on a display of the vehicle.

12. The information processing method according to claim 11, wherein
the computer displays the information relating to the request when confirming whether or not the operation to cancel the contract of the services has been performed from the first user.

13. The information processing method according to claim 11, wherein
the computer displays the information relating to the request when the first user inputs an account or a password to cancel the contract.

14. The information processing method according to claim 11, wherein
the computer displays a telephone number in the information relating to the request.

15. The information processing method according to claim 11, wherein
the computer displays, in the information relating to the request, information relating to URLs capable of requesting cancellation of the contract.

16. The information processing method according to claim 11, wherein
the computer causes the display to display information relating to the first user.

17. The information processing method according to claim 16, wherein
the computer causes information regarding the first user to be displayed on menus of the services.

18. The information processing method according to claim 16, wherein
the computer displays information relating to the first user e-mail address on the display as the information relating to the first user.

19. The information processing method according to claim 16, wherein
the computer displays the first user name or nickname on the display as the information relating to the first user.

20. A vehicle comprising a controller configured to perform:
obtaining information relating to an operation to cancel a contract for a service provided in a vehicle; and,
when obtaining the information relating to the operation to cancel the contract for the service, causing an information relating to a request when a second user, which differs from a first user to which the service is contracted, cancels the contract, to be displayed on a display of the vehicle.
